(19) United States
(12) Patent Application Publication
(10) Pub. No.: US 2008/0251660 A1
(43) Pub. Date: Oct. 16, 2008

(54) Toon jack, a support fixture designed to store, display and support watercraft, specifically pontoon boats, on dry land

(76) Inventor: Steven L. Spyker, Sturgis, MI (US)

Correspondence Address: Steven L. Spyker, 24562 Butternut Drive, Sturgis, MI, 49091, US

(21) Appl. No.: 11/879,608

(22) Filed: Jul. 18, 2007

Related U.S. Application Data
(60) Provisional application No. 60/831,588, filed on Jul. 19, 2006.

(51) Int. Cl. F16M 11/00

(52) U.S. Cl. 248/176.1

(57) ABSTRACT

Toon Jacks provide an improved, dry land storage or display system for pontoon boats. Each Toon Jack is a four sided pyramid or conically shaped structure with a concave top surface exposing a “V” shaped groove running horizontally across the top between two opposing sides, or as a diameter if the structure is conical. This top surface configuration provides a secure, stable support when the unit is placed underneath each pontoon boat float tube, in front and rear positions. The units are constructed of a lightweight, multi-colorable, foam cored co-polymer plastic and are shaped through an injection molding process. Each unit may have cutouts on opposing sides to permit handling and ventilation and the units can be stacked when not in use. The units can be modified to permit wheels to be attached allowing the supported watercraft to be rolled into a display position or storage location.

### PRIOR APPLICATION

Applicant claims priority benefits under Provisional Patent Application Appl. No. 60/831,588 filed Jul. 19, 2006.

### TECHNICAL FIELD

Toon Jack is a lightweight foam cored co-polymer plastic shaped boat storage fixture, created through an injection molding process that provides exceptional strength, easy use, and stackable storage when the fixture is not in use.

### BACKGROUND INFORMATION

Current pontoon boat users, manufacturers and showrooms currently utilize a variety of inefficient, corrosive and unwieldy devices to store or display their boats. Concrete, cinder or wooden blocks are the typical consumers' choice for dry land storage for pontoon boats. Marinas may utilize something along the lines of boat stands such as U.S. Pat. No. 5,290,124 Pavlescak. Display showrooms routinely set their products on carpets directly on the floor or on cumbersome rolling wooden frames. Toon Jack provides a lightweight, plastic storage or display option, and can be equipped with wheels permitting the boat to be moved easily and in any direction. Toon Jack, due to its composition will not damage or corrode the pontoon floats while they rest on top of the invention, nor will the float keel be damaged due to the concave top design. When not in use, each Toon Jack is designed to stack on top of each other unit, permitting easy storage.

### SUMMARY OF INVENTION

Toon Jack is a four sided pyramid or conically shaped structure with a concave top surface and rounded edges exposing a “V” shaped groove running horizontally across the top between two opposing sides, or as a diameter if the structure is conical. The top surface configuration provides a means of secure, stable support when the structure is placed underneath each pontoon boat float tubes, in a front and rear position, thus facilitating placement onto and off of a transport mechanism as well as for a raised stationary storage position while the pontoon boat is not afloat. The structure is constructed of a multi-colorable, recyclable foam cored co-polymer plastic and is shaped through an injection molding process. Each structure may have cutouts on opposing sides to permit easy handling and ventilation and each structure can be modified so that wheels may be attached permitting a pontoon boat being supported by the structures to be rolled into a display position or storage location. The structure can potentially be constructed in a variety of sizes, if desired, to accommodate specific boats or uses; i.e., display or storage heights. The structures are most commonly envisioned to be approximately six to fourteen inches (6″-14″) high with a base of approximately ten to twenty-four (10″-24″) square inches.

### BRIEF DESCRIPTION OF THE DRAWINGS

For purposes of illustrating the invention, there is shown in the drawings forms which are presently preferred; It being understood, however, that the invention is not limited to the precise arrangements and instrumentalities shown, in the drawings, which form a part of this specification,

FIG. 1 is a three-dimensional rendering of the invention.

FIG. 2 is side elevation view of the invention shown in FIG. 1.

FIG. 3 is a cutaway side elevation view of the invention shown in FIG. 1 and FIG. 2.

FIG. 4 is top view of the invention shown in FIG. 1, FIG. 2 and FIG. 3.

FIG. 5 is top view of the invention shown in an alternate conical configuration, as opposed to FIG. 1-4, which display the invention in a four sided pyramid configuration.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description in conjunction with the accompanying drawings.

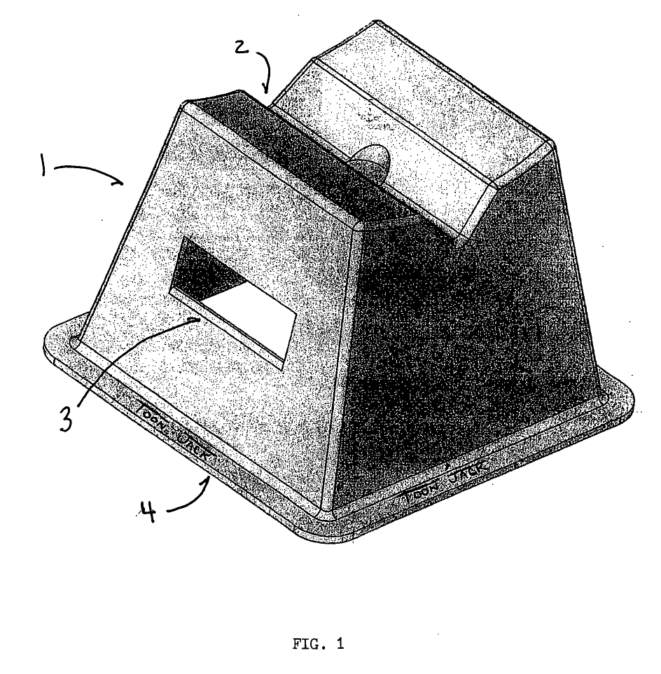

Referring now to the drawings in detail, where like numerals refer to like parts or elements, FIG. 1 depicts the invention 1 in a four sided pyramid configuration, the “V” shaped groove 2 on the top surface which accommodates the float keel of a pontoon boat float, the cutouts 3 for handling and ventilation and the bottom flange 4 on which the invention sits on land, and can be modified to accept screws or bolts for mounting a platform containing wheels.

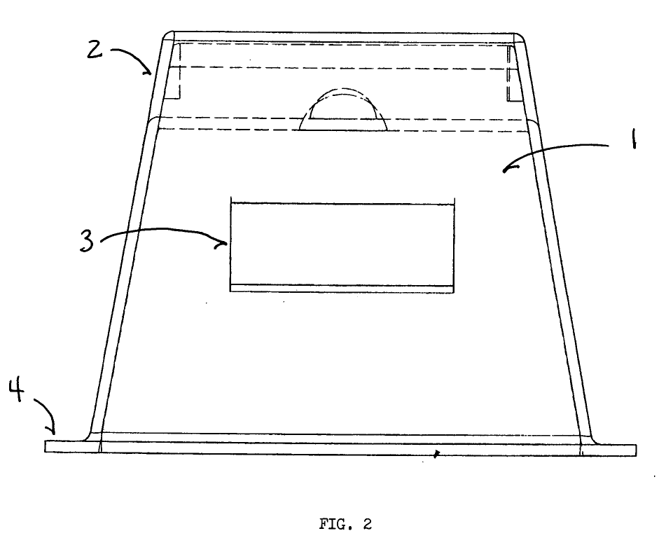

FIG. 2 depicts a side view of the invention 1, along with the distinguishing features: “V” groove 2, cutouts 3 and bottom flange 4.

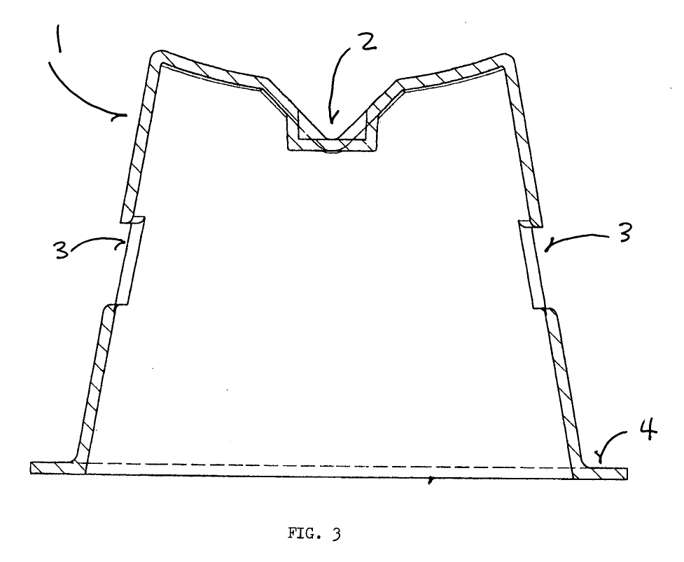

FIG. 3 is a cutaway view of the invention 1, the “V” groove 2, the rounded edges of the cutout 3 and the bottom flange 4.

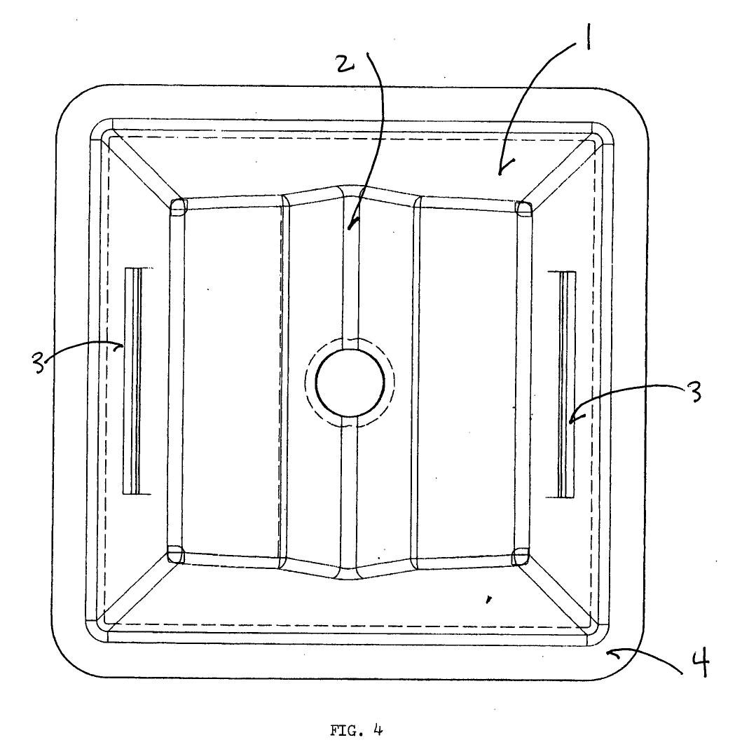

FIG. 4 is a top view of the invention 1, the “V” groove 2, the cutouts 3 and the bottom flange 4.

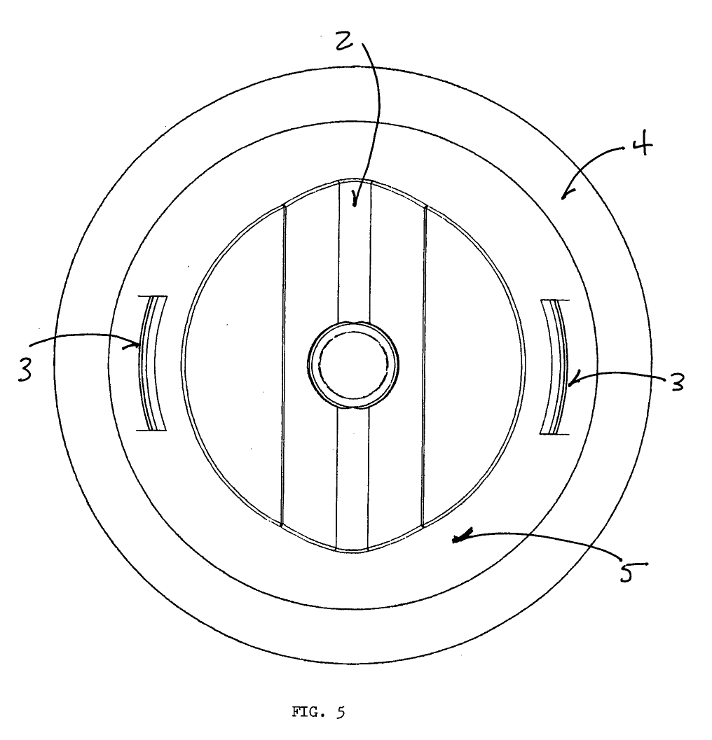

FIG. 5 is a top view of the invention in a conical configuration 5, the “V” groove 2, the cutout 3 and the bottom flange 4.

The embodiments of the invention in which an exclusive property or privilege is claimed are defined as follows:

1. A Toon Jack boat stand system comprised of multiple four sided pyramid or conically shaped plastic units;
each unit to have a concave top and rounded edges exposing a “V” shaped groove running horizontally across the top surface between two opposing sides, or as a diameter if the unit is conical;
each unit to have a flange at the bottom, said flange to be parallel to the ground surface on which to rest the unit.

2. A Toon Jack boat stand unit is comprised of a multi-colorable, foam cored co-polymer plastic, either recyclable or not, shaped as noted in claim 1, through an injection molding process;
each unit may contain cutouts or handholds on opposite sides of the unit permitting handling and ventilation;
each unit to contain a molded bottom flange capable of being modified to accept the attachment of a wheeled platform enabling the supported watercraft to be easily moved.

3. Each Toon Jack boat stand unit is comprised of a molded plastic structure as described in claims 1 and 2, with a bottom flange that can be molded with locater holes to accept a screw or bolt attached plate with wheels, permitting the unit to be rolled, whether supporting a watercraft or not.
